(19) United States
(12) Patent Application Publication
(10) Pub. No.: US 2008/0301966 A1
(43) Pub. Date: Dec. 11, 2008

(54) SIDING INSTALLATION SYSTEM AND METHOD

(76) Inventor: Bruce Walther, St. Augustine, FL (US)

Correspondence Address: MARK YOUNG, P.A., 12086 FORT CAROLINE ROAD, UNIT 202, JACKSONVILLE, FL, 32225, US

(21) Appl. No.: 11/760,518

(22) Filed: Jun. 8, 2007

(51) Int. Cl. E04G 21/16; G01D 21/00

(52) U.S. Cl. 33/649; 414/10

(57) ABSTRACT

A system for installing lap siding includes a stationary installation tool used in conjunction with a moveable installation tool to enable a single worker to efficiently and consistently achieve a high quality installation with parallel planks and a uniform exposure. The stationary installation tool features a planar face, a first stationary edge support, a second stationary edge support and an attachment component such as an aperture for receiving a nail or screw. The first stationary edge support and second stationary edge support define a determined overlap or exposure. The moveable installation tool has a planar face, a first moveable edge support and a second moveable edge support. The first moveable edge support and second moveable edge support are configured to define a determined overlap or exposure consistent with that defined by the first stationary edge support and second stationary edge support.

### FIELD OF THE INVENTION

This invention generally relates to exterior siding, and, more particularly, to a system comprised of a pair of tools to facilitate installation of lap siding, particularly fiber cement siding.

### BACKGROUND

Nothing impacts the appearance of a home more dramatically than exterior siding. Siding options include wood clapboard comprised of solid wood, usually cedar, pine, spruce, redwood, cypress, or douglas fir; fiber cement best known by the brand names HardiPlank® and HardiPanel®; engineered wood or composite wood made with wood products and other materials, steel, aluminum and vinyl.

Fiber cement siding is typically made from Portland cement mixed with ground sand, cellulose fiber, and other additives. It can resemble stucco, wood clapboards, or cedar shingles, depending on how the panels are textured. It is more durable than wood or stucco, and is also fire resistant. Although more expensive than vinyl, fiber cement siding is considerably less expensive than wood. It has become popular because it requires little maintenance and can have a natural, wood-like appearance. It is well known by the brand names HardiPlank® and HardiPanel® for fiber cement siding manufactured by James Hardie Building Products.

Fiber cement siding, such as Hardiplank® siding, is typically about 5/16″ thick and 12′ long, and comes in heights ranging from about 5¼″ to 12″, and weighing about 2.3 lbs/sq.ft, i.e., about 12 to 28 pounds per plank. During installation each row (i.e., course) of lap siding overlaps the row below it by about 1¼″. A starter row called a lath strip is used below the first course of siding to ensure a consistent plank angle. The distance between the bottoms of adjacent planks is called the exposure or reveal. A high quality installation features parallel planks and a consistent exposure all over the house. Corrosion resistant screws or nails (galvanized or stainless steel) are typically used to secure the siding to the side of the house.

Despite the many advantages of siding, such as fiber cement siding, it has drawbacks. Installation is laborious and susceptible to error. Typically, at least two workers are required to properly install fiber cement siding because the planks are long, heavy and must be properly located and aligned. A sole worker cannot hold a plank in a correct position while measuring and/or fastening it to a house. Even with two workers attending to installation, slight yet noticeable deviations from the desired exposure or parallel are common.

As a consequence of the foregoing, there exists a longstanding need for a new and improved system and method for installing siding. The system should be easy to apply to and remove from siding. It should work with flexible (e.g., vinyl) and rigid (e.g., fiber cement), lightweight and heavy siding. It should facilitate high quality installation by a single worker.

The invention is directed to overcoming one or more of the problems and fulfilling one or more of the needs as set forth above.

### SUMMARY OF THE INVENTION

To overcome one or more of the problems and fulfill one or more of the needs as set forth above, in one aspect of an exemplary embodiment of the invention a system for installing lap siding is provided. The system includes a stationary installation tool used in conjunction with a moveable installation tool to enable a single worker to efficiently and consistently achieve a high quality installation with parallel planks and a uniform exposure. The stationary installation tool features a planar face, a first stationary edge support, a second stationary edge support and an attachment component such as an aperture for receiving a nail or screw. The first stationary edge support and second stationary edge support define a determined overlap or exposure. The moveable installation tool has a planar face, a first moveable edge support and a second moveable edge support. The first moveable edge support and second moveable edge support are configured to define a determined overlap or exposure consistent with that defined by the first stationary edge support and second stationary edge support.

In one aspect of an exemplary implementation of the invention, a system for installing siding is provided. The system includes a stationary installation tool and a moveable installation tool. The stationary installation tool includes a planar face having a front surface and a back surface, a first stationary edge support, a second stationary edge support and an attachment means. The first stationary edge support and said second stationary edge support define a determined overlap or exposure. The moveable installation tool includes a planar face, a first moveable edge support, and a second moveable edge support. The first moveable edge support and second moveable edge support are configured to define a determined overlap or exposure.

In another aspect of an exemplary implementation of the invention, the first stationary edge support is adapted to support a portion of a bottom edge of a plank of siding to be installed, while the second stationary edge support is adapted to abut a portion of a top edge of a plank of siding that has been installed.

In another aspect of an exemplary implementation of the invention, the first stationary edge support and said second stationary edge support are parallel.

In another aspect of an exemplary implementation of the invention, the attachment means is an aperture configured for receiving a mechanical attachment, such as a nail, screw or staple, to secure the stationary installation tool to a wall on which siding is being installed.

In another aspect of an exemplary implementation of the invention, the distance from the aperture to the first stationary edge support is greater than the height of a plank of siding to be installed.

In another aspect of an exemplary implementation of the invention, the distance from the first stationary edge support to the second stationary edge support is less than the height of a plank of siding to be installed.

In another aspect of an exemplary implementation of the invention, the first stationary edge support protrudes from the front surface of the planar face of the stationary installation tool, while the second stationary edge support protrudes from the back surface of the planar face of the stationary installation tool.

In another aspect of an exemplary implementation of the invention, the first moveable edge support is adapted to support a portion of a bottom edge of a plank of siding to be installed while the second moveable edge support is adapted to abut a portion of a top edge of a plank of siding that has been installed.

In another aspect of an exemplary implementation of the invention, the first moveable edge support and said second moveable edge support are parallel.

In another aspect of an exemplary implementation of the invention, the distance from said first moveable edge support to said second moveable edge support is less than the height of a plank of siding to be installed.

In another aspect of an exemplary implementation of the invention, the first moveable edge support protrudes from the front surface of the planar face of the moveable installation tool, while the second moveable edge support protrudes from the front surface of the planar face of the moveable installation tool.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary stationary installation tool according to principles of the invention;

FIG. 2 is a perspective view of an exemplary moveable installation tool according to principles of the invention;

FIG. 3 is a perspective view of another exemplary moveable installation tool according to principles of the invention;

FIG. 4 is a perspective view of yet another exemplary moveable installation tool according to principles of the invention;

FIG. 5 is a side section view of an exemplary stationary installation tool and planks being installed according to principles of the invention;

FIG. 6 is a side section view of an exemplary moveable installation tool and planks being installed according to principles of the invention;

FIG. 7 is a side section view of another exemplary moveable installation tool and planks being installed according to principles of the invention;

FIG. 8 is a side section view of another exemplary moveable installation tool and planks being installed according to principles of the invention;

FIG. 9 is a side section view of another exemplary moveable installation tool and planks being installed according to principles of the invention;

FIG. 10 is a side section view of another exemplary moveable installation tool and planks being installed according to principles of the invention;

FIG. 11 is a side section view of another exemplary moveable installation tool and planks being installed according to principles of the invention;

FIG. 12 is a front perspective view of a preferred exemplary stationary installation tool according to principles of the invention;

FIG. 13 is a back perspective view of a preferred exemplary stationary installation tool according to principles of the invention;

FIGS. 14A, 14B and 14C are a dimensioned front side and back plan views of a preferred exemplary stationary installation tool according to principles of the invention;

FIGS. 15A through 15E are a dimensioned section views of a preferred exemplary stationary installation tool according to principles of the invention;

FIG. 16 is a front perspective view of a preferred exemplary moveable installation tool according to principles of the invention;

FIG. 17 is a back perspective view of a preferred exemplary moveable installation tool according to principles of the invention;

FIGS. 18A, 18B and 18C are a dimensioned top, front and side plan views of a preferred exemplary moveable installation tool according to principles of the invention;

FIGS. 19A through 19F are a dimensioned section views of a preferred exemplary moveable installation tool according to principles of the invention.

Those skilled in the art will appreciate that the figures are not intended to be limited to the shapes, sizes and/or proportions shown in the figures.

### DETAILED DESCRIPTION

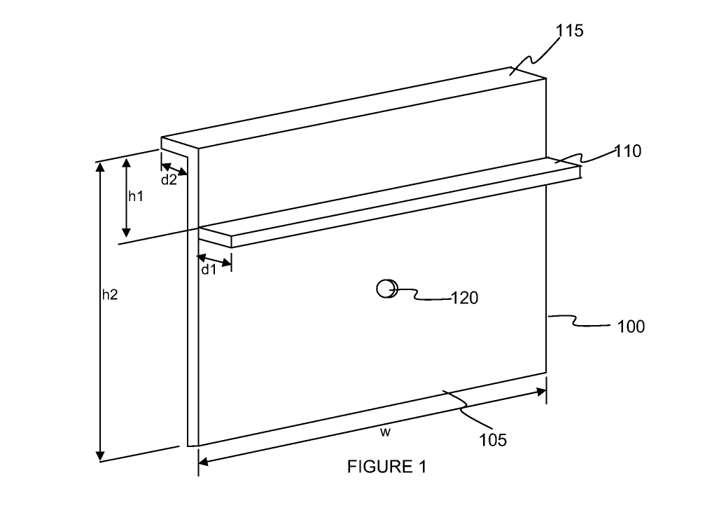

Referring to FIG. 1, a perspective view of an exemplary stationary installation tool 100 according to principles of the invention is shown. In general, the exemplary stationary installation tool 100 is comprised of a planar face 105, a top edge support 115 and a bottom edge support 110. The top edge support 115 is generally perpendicular to the planar face 105 of the exemplary stationary installation tool 100 and projects from the top edge of the planar face 105. The bottom edge support 110 is generally perpendicular to the planar face 105 of the exemplary stationary installation tool 100 and is parallel to the top edge support 115. An aperture 120 is provided for receiving a nail or screw to secure the tool 100 to a plank, or (as described below) to a wall.

Those skilled in the art will appreciate that an exemplary stationary installation tool 100 according to principles of the invention, as shown in FIG. 1, is sized to function with planks. The bottom side of the top edge support 115 is adapted to rest on the top edge of an installed plank, while the bottom edge of an adjacent plank rests on the top side of the bottom edge support 110. Thus, the distance h between the bottom side of the top edge support 115 and the top side of the bottom edge support 110 defines the overlap. Illustratively, if each course of siding overlaps the row below it by about 1¼″, h is approximately 1¼″.

The depths d1 and d2 of the bottom edge support 110 and top edge support 115 are sufficient to engage the siding. Fiber cement siding, such as Hardiplank® siding, is typically about 5/16″ thick. Therefore, to engage the siding while enabling the back side of the planar face 105 to rest flush against an installed plank, the depth d2 of the top edge support 115 should be about the thickness of the siding (e.g., 5/16″) or less. A right angle between the planar face 105 and the top edge support 115 also helps ensure that the back side of the planar face 105 rests flush against an installed plank. The depth d1 of the bottom edge support 110 should be about the thickness of the siding (e.g., 5/16″) or greater. A right angle between the planar face 105 and the bottom edge support 110 helps ensure that the back side of the planar face 105 rests flush against an installed plank.

The width w of the tool 100 should be sufficient to provide a stable surface to rest against a plank without being cumbersome to handle. A broad range of widths w may be utilized within the scope of the invention. By way of example and not limitation, the width may be about ¾″ to several (e.g., 6) inches. A width much less than ¾″ risks instability, such as by wobbling. A width much greater than 6 inches may make the tool 100 difficult to manipulate.

An exemplary stationary installation tool 100 according to principles of the invention, as shown in FIG. 1, may be comprised of any material that provides adequate structural properties to support planks in a desired position. By way of example and not limitation, the installation tool 100 can be made of metal, plastic, wood and composite materials. The planar face 105 and the top edge support 115 of the tool 100 may be comprised of one piece of material with a bend. The tool 100 may be formed by casting or molding or any other suitable process now known or later developed. The bottom edge support 110 may be an integrally formed part of the tool 100 or a separate part that is attached to the tool by any suitable chemical, thermal and/or mechanical attachments.

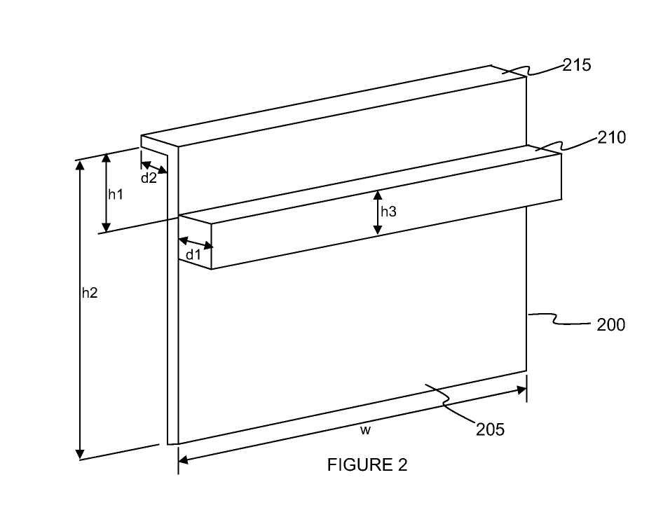

Referring now to FIG. 2, a perspective view of an exemplary moveable installation tool 200 according to principles of the invention is shown. In general, the exemplary moveable installation tool 200 is comprised of a planar face 205, a top edge support 215 and a bottom edge support 210. The top edge support 215 is generally perpendicular to the planar face 205 of the exemplary moveable installation tool 200 and projects from the top edge of the planar face 205. The bottom edge support 210 is generally perpendicular to the planar face 205 of the exemplary moveable installation tool 200 and is parallel to the top edge support 215. The bottom edge support 210 may also serve as a handle to facilitate manipulation of the tool 200. Optionally, an ergonomic grip may be attached to the free end of the bottom edge support 210.

Those skilled in the art will appreciate that an exemplary moveable installation tool 200 according to principles of the invention, as shown in FIG. 2, is sized to function with planks. The bottom side of the top edge support 215 is adapted to rest on the top edge of an installed plank, while the bottom edge of an adjacent plank rests on the top side of the bottom edge support 210. Thus, the distance h between the bottom side of the top edge support 215 and the top side of the bottom edge support 210 defines the overlap. Illustratively, if each course of siding overlaps the row below it by about 1¼″, h is approximately 1¼″.

The depths d1 and d2 of the bottom edge support 210 and top edge support 215 are sufficient to engage the siding. Assuming use with siding of about 5/16″ thick, to engage the siding while enabling the back side of the planar face 205 to rest flush against an installed plank, the depth d2 of the top edge support 215 should be about the thickness of the siding (e.g., 5/16″) or less. A right angle between the planar face 205 and the top edge support 215 also helps ensure that the back side of the planar face 205 rests flush against an installed plank. The depth d1 of the bottom edge support 210 should be about the thickness of the siding (e.g., 5/16″) or greater. A right angle between the planar face 205 and the bottom edge support 210 helps ensure that the back side of the planar face 205 rests flush against an installed plank.

The width w of the tool 200 should be sufficient to provide a stable surface to rest against a plank without being cumbersome to handle. A broad range of widths w may be utilized within the scope of the invention. By way of example and not limitation, the width may be about ¾″ to several (e.g., 6) inches. A width much less than ¾″ risks instability, such as by wobbling. A width much greater than 6 inches may make the tool 200 difficult to manipulate.

An exemplary moveable installation tool 200 according to principles of the invention, as shown in FIG. 2, may be comprised of any material that provides adequate structural properties to support planks in a desired position. By way of example and not limitation, the installation tool 200 can be made of metal, plastic, wood and composite materials. The planar face 205 and the top edge support 215 of the tool 200 may be comprised of one piece of material with a bend. The tool 200 may be formed by casting or molding or any other suitable process now known or later developed. The bottom edge support 210 may be an integrally formed part of the tool 200 or a separate part that is attached to the tool by any suitable chemical, thermal and/or mechanical attachments.

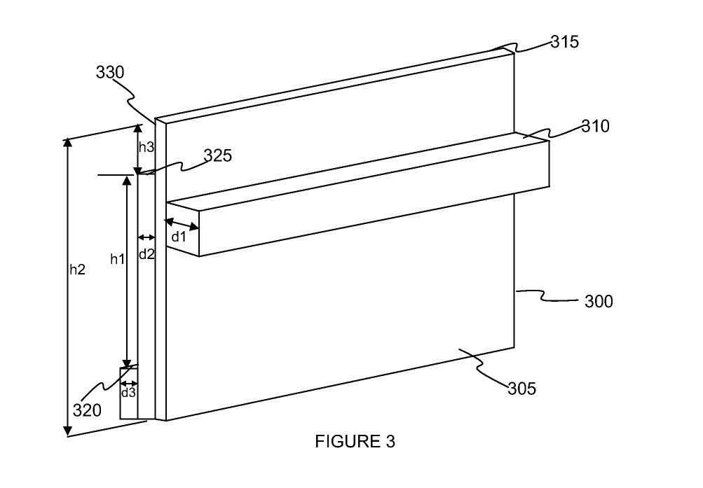

Referring now to FIG. 3, a perspective view of an alternative exemplary moveable installation tool 300 according to principles of the invention is shown. In general, the alternative exemplary moveable installation tool 300 is comprised of a planar face 305, a lower bottom edge support 320, an upper bottom edge support 325 and a handle 310. The lower bottom edge support 320 is generally perpendicular to the planar face 305 of the exemplary moveable installation tool 300. The upper bottom edge support 325 is generally perpendicular to the planar face 305 of the exemplary moveable installation tool 300 and is parallel to the lower bottom edge support 320. The handle 310 facilitates manipulation of the tool 300. Optionally, an ergonomic grip may be attached to the free end of the handle 310.

Those skilled in the art will appreciate that an exemplary moveable installation tool 300 according to principles of the invention, as shown in FIG. 2, is sized to function with planks. The top side of the lower bottom edge support 320 is adapted to rest against the bottom edge of an installed plank, while the bottom edge of an adjacent plank being installed rests on the top side of the upper bottom edge support 325. Thus, the distance h1 between the top side of the lower bottom edge support 320 and the top side of the upper bottom edge support 325 defines the exposure. Illustratively, if each course of siding has an exposure of about 6¾″, h1 is approximately 6¼″.

The depths d2 and d3 of the upper bottom edge support 325 and lower bottom edge support 320 are sufficient to engage the siding. Assuming use with siding of about 5/16″ thick, to engage the siding the depth d2 of the lower bottom edge support 320 should be about the thickness of the siding (e.g., 5/16″). The depth d3 of the upper bottom edge support 325 should also be about the thickness of the siding (e.g., 5/16″).

The width w of the tool 300 should be sufficient to provide a stable surface to rest against a plank without being cumbersome to handle. A broad range of widths w may be utilized within the scope of the invention. By way of example and not limitation, the width may be about ¾″ to several (e.g., 6) inches. A width much less than ¾″ risks instability, such as by wobbling. A width much greater than 6 inches may make the tool 300 difficult to manipulate and cumbersome to transport.

An exemplary moveable installation tool 300 according to principles of the invention, as shown in FIG. 3, may be comprised of any material that provides adequate structural properties to support planks in a desired position. By way of example and not limitation, the installation tool 300 can be made of metal, plastic, wood and composite materials. The planar face 305 and the lower bottom edge support 320 of the tool 300 may be comprised of one piece of material with a bend. The tool 300 may be formed by casting or molding or any other suitable process now known or later developed. The upper bottom edge support 325 may be an integrally formed part of the tool 300 or a separate part that is attached to the tool by any suitable chemical, thermal and/or mechanical attachments.

A handle 310 is provided to facilitate manipulation of the tool 300. Various handle configurations may be utilized with the tool 300 and are intended to come within the scope of the invention. Optionally, an ergonomic grip may be attached to the free end of the handle 310.

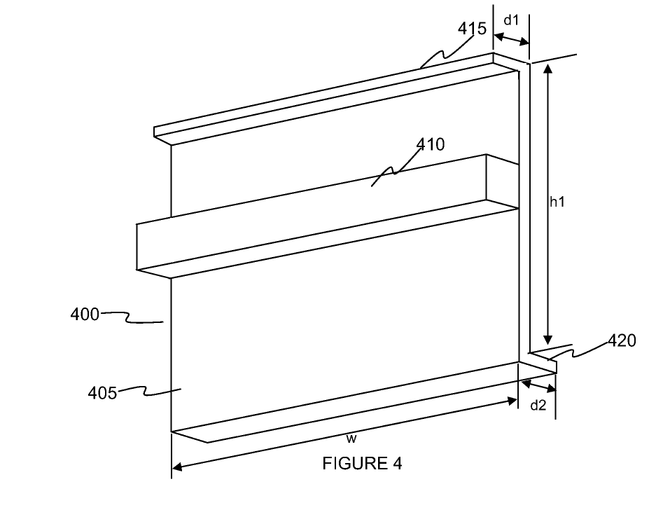

Referring now to FIG. 4, a perspective view of another alternative exemplary moveable installation tool 400 according to principles of the invention is shown. In general, this alternative exemplary moveable installation tool 400 is comprised of a planar face 405, a lower bottom edge support 420, an upper bottom edge support 415 and a handle 410. The lower bottom edge support 420 is generally perpendicular to the planar face 405 of the exemplary moveable installation tool 400. The upper bottom edge support 425 is generally perpendicular to the planar face 405 of the exemplary moveable installation tool 400 and is parallel to the lower bottom edge support 420. The handle 410 facilitates manipulation of the tool 400. Optionally, an ergonomic grip may be attached to the free end of the handle 410.

Those skilled in the art will appreciate that an exemplary moveable installation tool 400 according to principles of the invention, as shown in FIG. 4, is sized to function with planks. The top side of the lower bottom edge support 420 is adapted to rest against the bottom edge of an installed plank, while the bottom edge of an adjacent plank being installed rests on the top side of the upper bottom edge support 415. Thus, the distance h1 between the top side of the lower bottom edge support 420 and the top side of the upper bottom edge support 415 defines the exposure. Illustratively, if each course of siding has an exposure of about 6¾″, h1 is approximately 6¼″.

The depths d1 and d2 of the upper bottom edge support 415 and lower bottom edge support 420 are sufficient to engage the siding. Assuming use with siding of about 5/16″ thick, to engage the siding the depth d2 of the lower bottom edge support 420 should be about the thickness of the siding (e.g., 5/16″). The depth d1 of the upper bottom edge support 415 should also be about the thickness of the siding (e.g., 5/16″) or greater.

The width w of the tool 400 should be sufficient to provide a stable surface to rest against a plank without being cumbersome to handle. A broad range of widths w may be utilized within the scope of the invention. By way of example and not limitation, the width may be about ¾″ to several (e.g., 6) inches. A width much less than ¾″ risks instability, such as by wobbling. A width much greater than 6 inches may make the tool 400 difficult to manipulate and cumbersome to transport.

An exemplary moveable installation tool 400 according to principles of the invention, as shown in FIG. 4, may be comprised of any material that provides adequate structural properties to support planks in a desired position. By way of example and not limitation, the installation tool 400 can be made of metal, plastic, wood and composite materials. The planar face 405 and the lower bottom edge support 420, and upper bottom edge support 415 of the tool 400 may be comprised of one piece of material with bends. The tool 400 may be formed by casting or molding or any other suitable process now known or later developed. The handle 410 may be an integrally formed part of the tool 400 or a separate part that is attached to the tool by any suitable chemical, thermal and/or mechanical attachments.

The handle 410 is provided to facilitate manipulation of the tool 400. Various handle configurations may be utilized with the tool 400 and are intended to come within the scope of the invention. Optionally, an ergonomic grip may be attached to the free end of the handle 410.

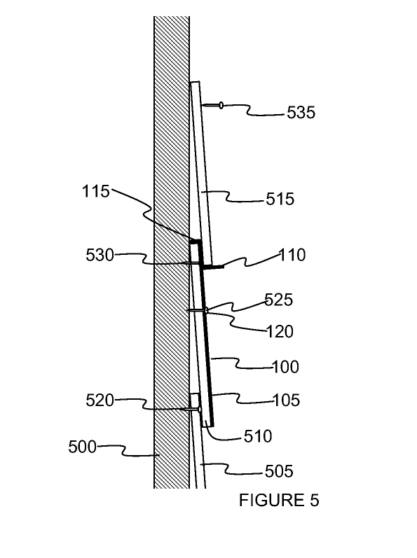

Referring now to FIG. 5, a side section view of an exemplary stationary installation tool 100 and planks being installed according to principles of the invention are shown. A plurality of overlapping planks 505-515 are secured to a wall 500 using a plurality of nails or screws 520,530 and 535. A nail or screw 525 secures the stationary installation tool 100 into an installation position. In general, the exemplary stationary installation tool 100 is comprised of a planar face 105, a top edge support 115 and a bottom edge support 110. The top edge support 115 is generally perpendicular to the planar face 105 of the exemplary stationary installation tool 100 and projects from the top edge of the planar face 105. The bottom edge support 110 is generally perpendicular to the planar face 105 of the exemplary stationary installation tool 100 and is parallel to the top edge support 115. An aperture 120 is provided for receiving a nail or screw 525 to secure the tool 100 to a plank. The bottom side of the top edge support 115 is adapted to rest on the top edge of an installed plank 510, while the bottom edge of an adjacent plank 515 rests on the top side of the bottom edge support 110.

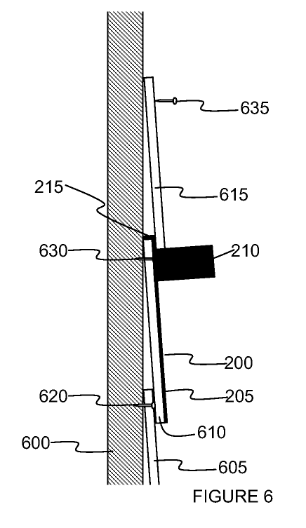

Referring now to FIG. 6, a side section view of an exemplary moveable installation tool 200 and planks being installed according to principles of the invention are shown. A plurality of overlapping planks 605-615 are secured to a wall 600 using a plurality of nails or screws 620-635. The moveable tool may be slid along the length of the planks 605-615. In general, the exemplary installation tool 200 is comprised of a planar face 205, a top edge support 215 and a bottom edge support 220. The top edge support 215 is generally perpendicular to the planar face 205 of the exemplary stationary installation tool 200 and projects from the top edge of the planar face 205. The bottom edge support 220 is generally perpendicular to the planar face 205 of the exemplary stationary installation tool 200 and is parallel to the top edge support 215. The bottom side of the top edge support 215 is adapted to rest on the top edge of an installed plank 620, while the bottom edge of an adjacent plank 615 rests on the top side of the bottom edge support 220. The bottom edge support 220 also serves as a handle.

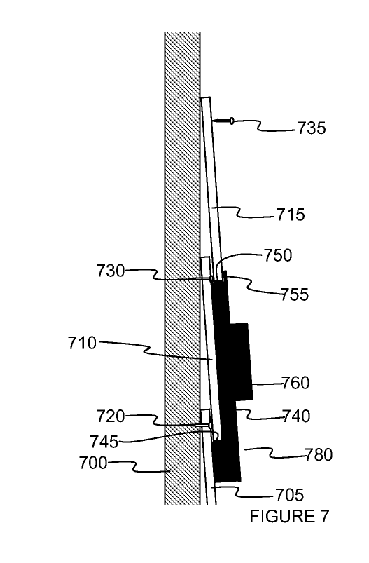

Referring now to FIG. 7, a side section view of yet another exemplary moveable installation tool 780 and planks being installed according to principles of the invention are shown. A plurality of overlapping planks 705-715 are secured to a wall 700 using a plurality of nails or screws 720-735. The moveable tool 780 may be slid along the length of the planks 705-715. In general, the exemplary installation tool 780 is comprised of a planar face 740, an upper bottom edge support 755 and a lower bottom edge support 745. The upper bottom edge support 750 is generally perpendicular to the planar face 740 of the exemplary stationary installation tool 780. The lower bottom edge support 745 is also generally perpendicular to the planar face 740 of the exemplary stationary installation tool 780, and is therefore parallel to the upper bottom edge support 750. The top surface of the upper bottom edge support 750 is adapted to rest against the bottom edge of a plank 715 to be installed, while the bottom edge of an adjacent installed plank 710 rests against the top surface of the lower bottom edge support 745. The tool 780 also includes a handle 760 to facilitate maneuvering.

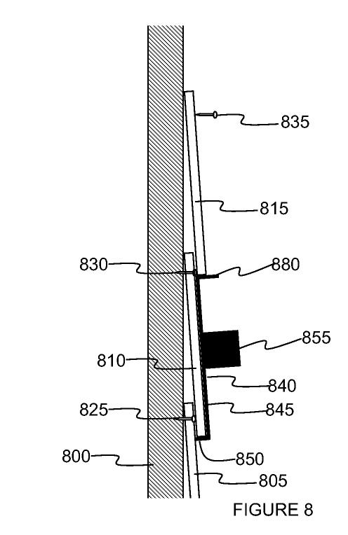

Referring now to FIG. 8, a side section view of a further exemplary moveable installation tool 840 and planks being installed according to principles of the invention are shown. A plurality of overlapping planks 805-815 are secured to a wall 800 using a plurality of nails or screws 820-835. The moveable tool 840 may be slid along the length of the planks 805-815. In general, the exemplary installation tool 840 is comprised of a planar face 845, an upper bottom edge support 880 and a lower bottom edge support 850. The upper bottom edge support 880 is generally perpendicular to the planar face 845 of the exemplary stationary installation tool 840. The lower bottom edge support 850 is also generally perpendicular to the planar face 845 of the exemplary stationary installation tool 840, and is therefore parallel to the upper bottom edge support 880. The top surface of the upper bottom edge support 880 is adapted to rest against the bottom edge of a plank 815 to be installed, while the bottom edge of an adjacent installed plank 810 rests against the top surface of the lower bottom edge support 850. The tool 840 also includes a handle 855 to facilitate maneuvering.

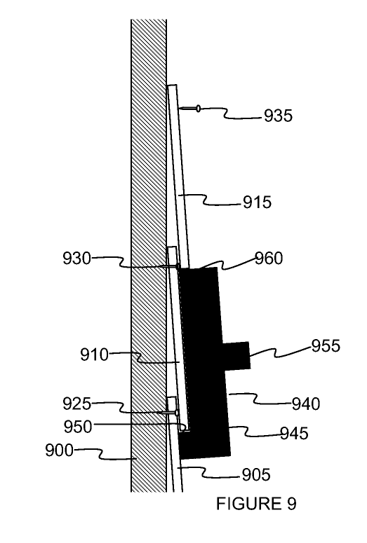

Referring now to FIG. 9, a side section view of yet a further exemplary moveable installation tool 940 and planks being installed according to principles of the invention are shown. A plurality of overlapping planks 905-915 are secured to a wall 900 using a plurality of nails or screws 920-935. The moveable tool 940 may be slid along the length of the planks 905-915. In general, the exemplary installation tool 940 is comprised of a planar face 945, an upper bottom edge support 960 and a lower bottom edge support 950. The upper bottom edge support 960 is generally perpendicular to the planar face 945 of the exemplary stationary installation tool 940. The lower bottom edge support 950 is also generally perpendicular to the planar face 945 of the exemplary stationary installation tool 940, and is therefore parallel to the upper bottom edge support 960. The top surface of the upper bottom edge support 960 is adapted to rest against the bottom edge of a plank 915 to be installed, while the bottom edge of an adjacent installed plank 910 rests against the top surface of the lower bottom edge support 950. The tool 940 also includes a handle 955 to facilitate maneuvering.

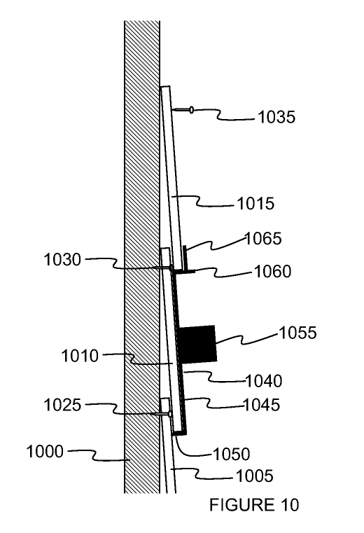

Referring now to FIG. 10, a side section view of yet a further exemplary moveable installation tool 1040 and planks being installed according to principles of the invention are shown. A plurality of overlapping planks 1005-1015 are secured to a wall 1000 using a plurality of nails or screws 1020-1035. The moveable tool 1040 may be slid along the length of the planks 1005-1015. In general, the exemplary installation tool 1040 is comprised of a planar face 1045, an upper bottom edge support 1060 and a lower bottom edge support 1050. The upper bottom edge support 1060 is generally perpendicular to the planar face 1045 of the exemplary stationary installation tool 1040, and includes a vertical flange 1065 configured to prevent the plank 1015 being installed from slipping off the support 1060. The lower bottom edge support 1050 is also generally perpendicular to the planar face 1045 of the exemplary stationary installation tool 1040, and is therefore parallel to the upper bottom edge support 1060. The top surface of the upper bottom edge support 1060 is adapted to rest against the bottom edge of a plank 1015 to be installed, while the bottom edge of an adjacent installed plank 1010 rests against the top surface of the lower bottom edge support 1050. The tool 1040 also includes a handle 1055 to facilitate maneuvering.

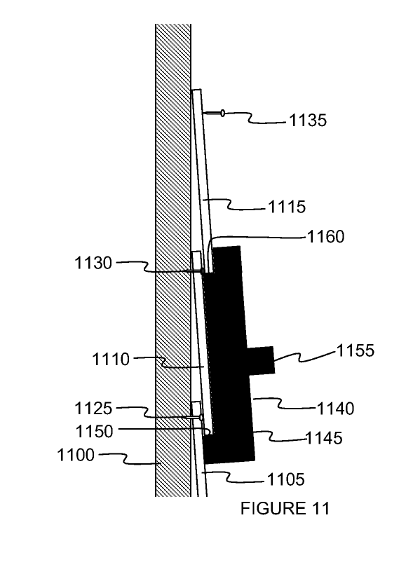

Referring now to FIG. 11, a side section view of yet a further exemplary moveable installation tool 1140 and planks being installed according to principles of the invention are shown. A plurality of overlapping planks 1105-1115 are secured to a wall 1000 using a plurality of nails or screws 1120-1135. The moveable tool 1140 may be slid along the length of the planks 1105-1115. In general, the exemplary installation tool 1140 is comprised of a planar face 1145, an upper bottom edge support 1160 and a lower bottom edge support 1150. The upper bottom edge support 1160 is generally perpendicular to the planar face 1145 of the exemplary stationary installation tool 1140, and includes a vertical flange 1165 configured to prevent the plank 1115 being installed from slipping off the support 1160. The lower bottom edge support 1150 is also generally perpendicular to the planar face 1145 of the exemplary stationary installation tool 1140, and is therefore parallel to the upper bottom edge support 1160. The top surface of the upper bottom edge support 1160 is adapted to rest against the bottom edge of a plank 1115 to be installed, while the bottom edge of an adjacent installed plank 1110 rests against the top surface of the lower bottom edge support 1150. The tool 1140 also includes a handle 1155 to facilitate maneuvering.

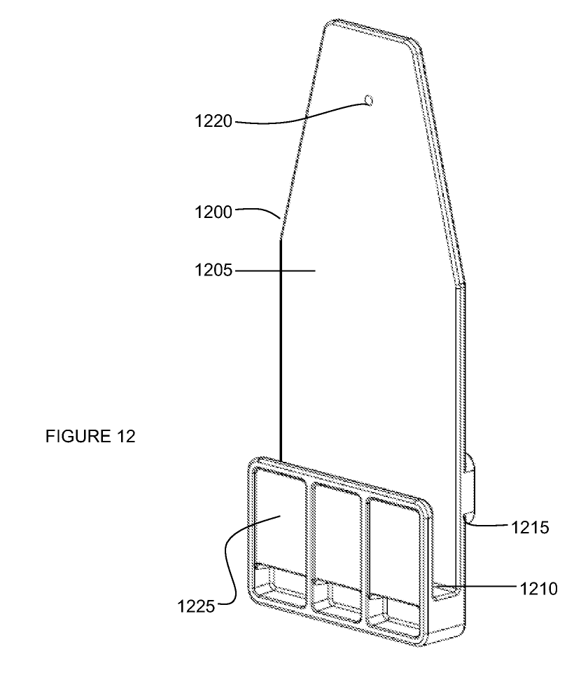

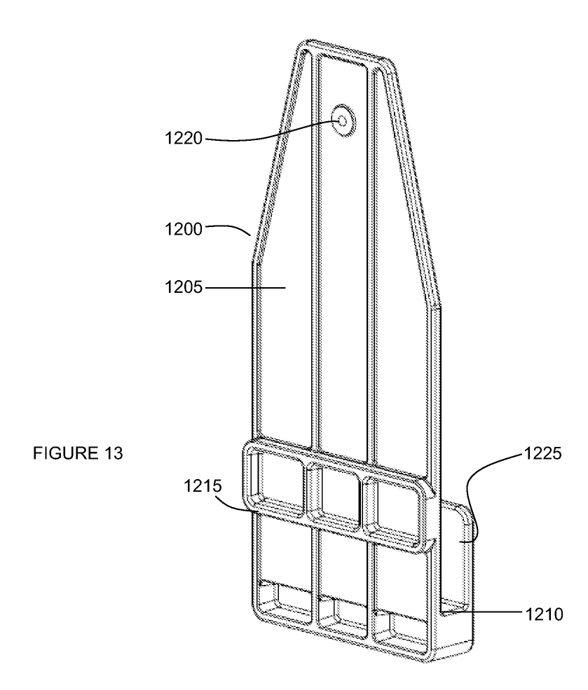

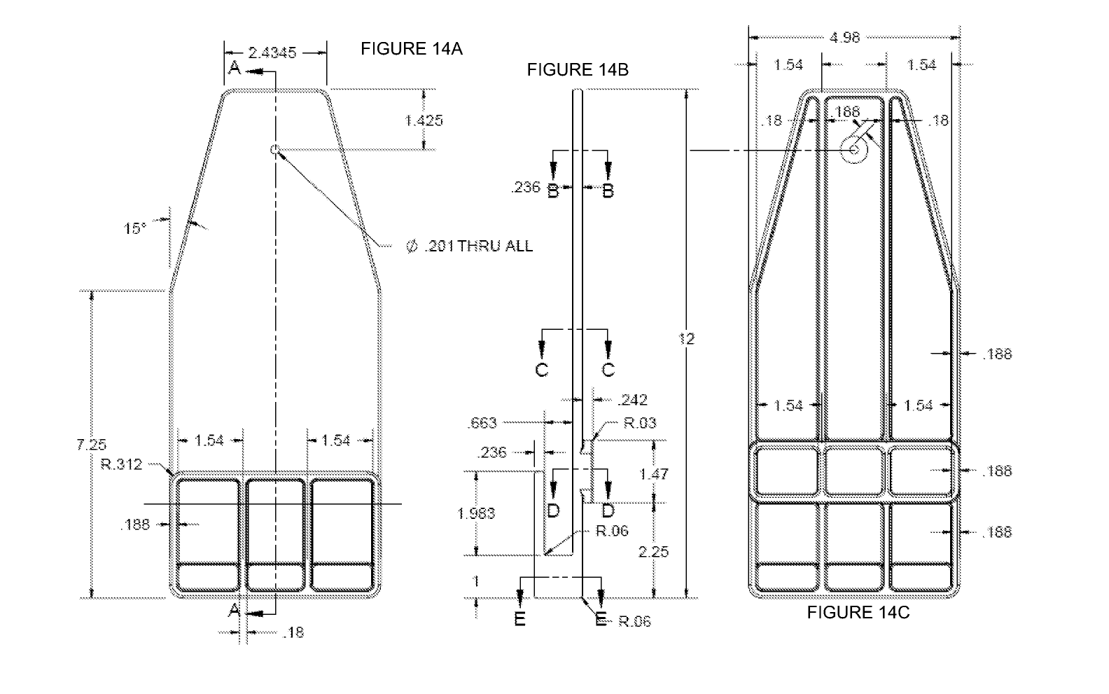

Referring to FIGS. 12 and 13, front and back perspective views of a preferred exemplary stationary installation tool 1200 according to principles of the invention are shown. In general, the exemplary stationary installation tool 1200 is comprised of a planar face 1205, a bottom edge support 1210 and a top edge support 1215. The top edge support 1215 is generally perpendicular to the planar face 1205 of the exemplary stationary installation tool 1200 and projects from the back surface of the planar face 1205. The bottom edge support 1210 is generally perpendicular to the planar face 1205 of the exemplary stationary installation tool 1200 and is parallel to the top edge support 1215. A bottom flange 1225 extends upwardly from the bottom edge support. The flange 1225 along with the bottom edge support 1210 and planar face 1205, define a unshaped support means. An aperture 1220 is provided for receiving a nail or screw to secure the tool 1200 to a wall above the location of the top edge of a plank being installed. Thus the top edge of the plank being installed is below the aperture 1220, when the bottom edge of said plank is against the bottom edge support. FIGS. 14A through 14C provide dimensions in inches of a preferred exemplary stationary installation tool 1200 according to principles of the invention.

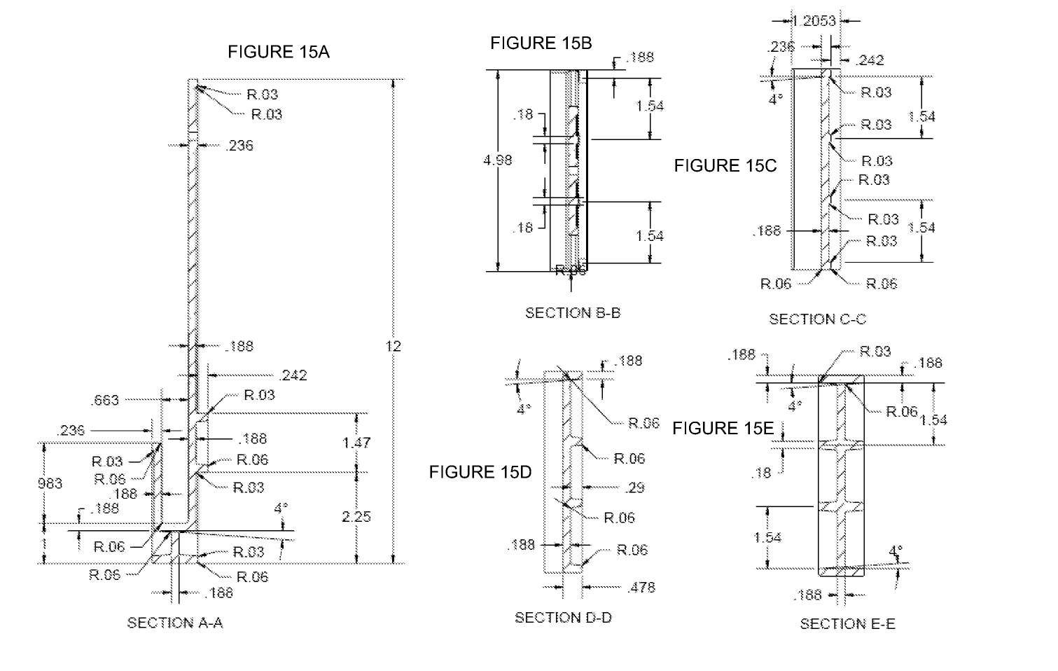

Those skilled in the art will appreciate that an exemplary stationary installation tool 1200 according to principles of the invention, as shown in FIG. 12, is sized to function with planks. The bottom side of the top edge support 1215 is adapted to rest on the top edge of an installed plank, while the bottom edge of an adjacent plank being installed rests on the bottom edge support 1210. Thus, the distance between the bottom side of the top edge support 1215 and the top side of the bottom edge support 1210 defines the overlap. Illustratively, if each course of siding overlaps the row below it by about 1¼″, the distance is approximately 1¼″. Additionally, the top edge of the plank being installed is below the aperture 1220, when the bottom edge of said plank is against the bottom edge support. FIGS. 15A through 15E provide dimensions in inches of sections of the preferred exemplary stationary installation tool 1200 according to principles of the invention. Those skilled in the art will appreciate that the invention is not limited to the depicted dimensions, shapes or proportions, and other dimensions, shapes and proportions may be utilized without departing from the scope of the present invention.

An exemplary stationary installation tool 1200 according to principles of the invention, as shown in FIG. 12, may be comprised of any material that provides adequate structural properties to support planks in a desired position. By way of example and not limitation, the installation tool 1200 can be made of metal, plastic, wood and composite materials. The tool 100 may be formed by casting or molding or any other suitable process now known or later developed. The bottom and top edge supports 1210 and 1215 may be an integrally formed part of the tools 1200 or separate parts that are attached to the tool 1200 by any suitable chemical, thermal and/or mechanical attachments.

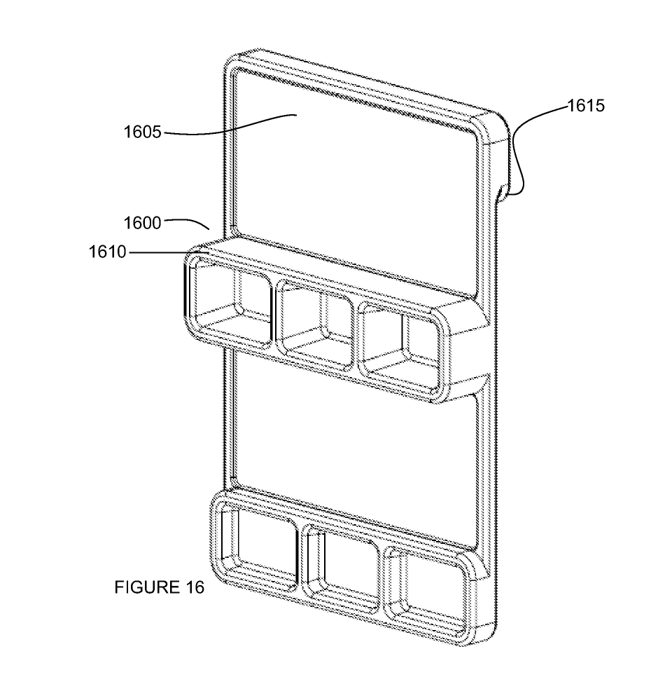

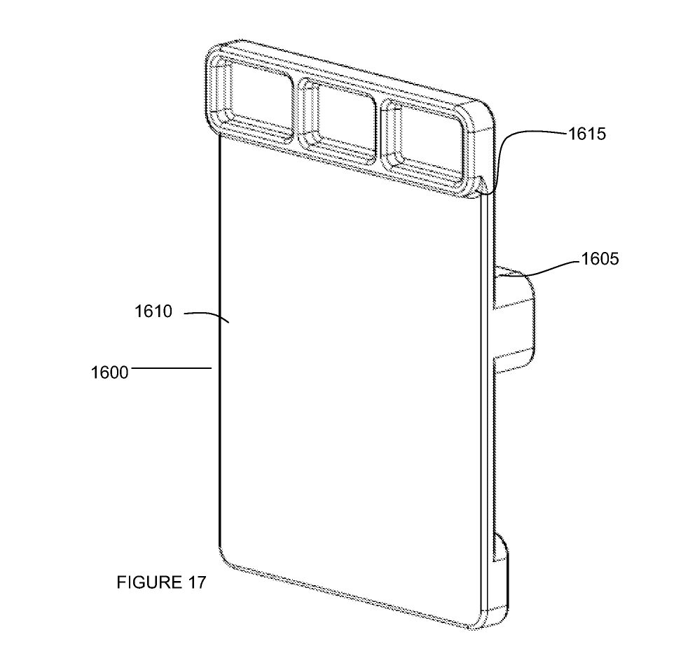

Referring now to FIGS. 16 and 17, front and back perspective views of an exemplary moveable installation tool 1600 according to principles of the invention is shown. In general, the exemplary moveable installation tool 1600 is comprised of a planar face 1605, a top edge support 1615 and a bottom edge support 1610. The top edge support 1615 is generally perpendicular to the planar face 1605 of the exemplary moveable installation tool 1600 and projects from the top edge of the back side of the planar face 1605. The bottom edge support 1610 is generally perpendicular to the planar face 1605 of the exemplary moveable installation tool 1600 and is parallel to the top edge support 1615. The bottom edge support 1610 also serves as a handle to facilitate manipulation of the tool 1600. Optionally, an ergonomic grip may be attached to the free end or some other portion of the bottom edge support 1610.

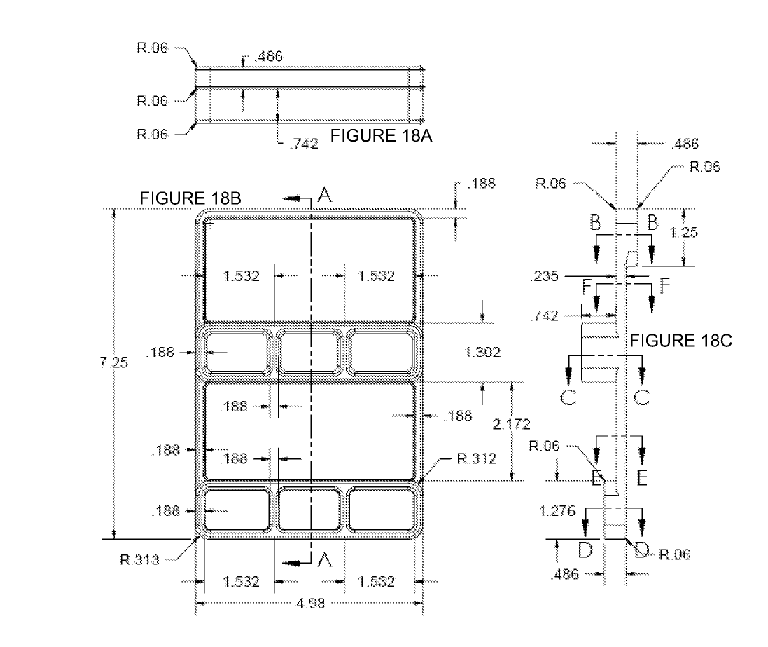

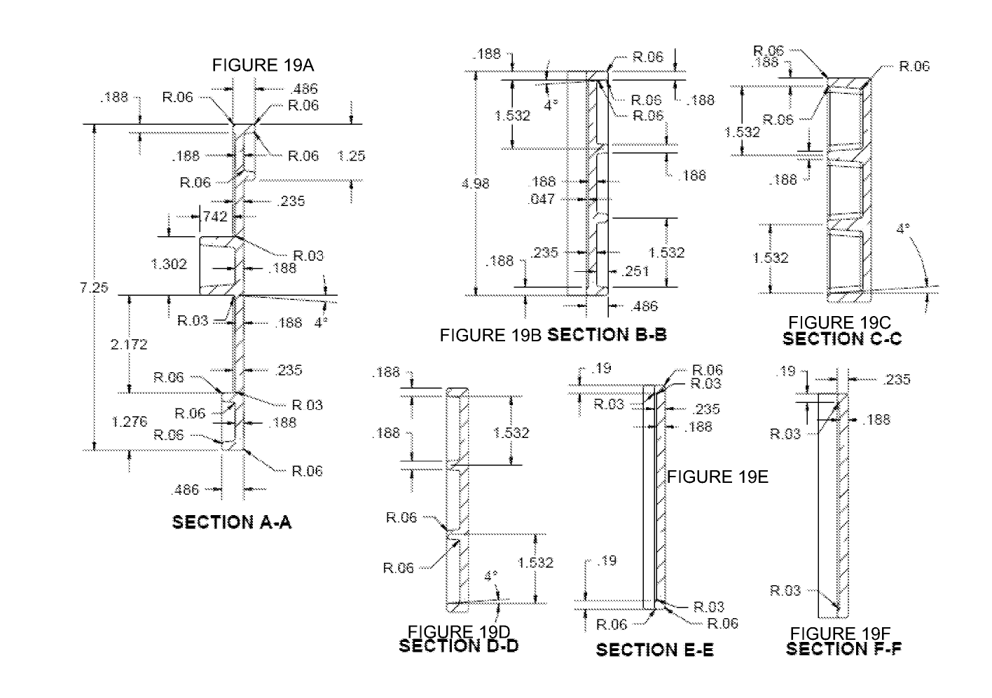

Those skilled in the art will appreciate that an exemplary moveable installation tool 1600 according to principles of the invention, as shown in FIGS. 16 through 19F, is sized to function with planks. FIGS. 18A through 18C provide dimensions in inches of top, front and side plan views of the preferred exemplary moveable installation tool 1600 according to principles of the invention. FIGS. 19A through 19F provide dimensions in inches of sections of the preferred exemplary stationary installation tool 1600 according to principles of the invention. Those skilled in the art will appreciate that the invention is not limited to the depicted dimensions, shapes or proportions, and other dimensions, shapes and proportions may be utilized within the spirit and scope of the present invention.

An exemplary moveable installation tool 1600 according to principles of the invention, as shown in FIGS. 16 through 19F, may be comprised of any material that provides adequate structural properties to support planks in a desired position. By way of example and not limitation, the installation tool 1600 can be made of metal, plastic, wood and composite materials. The tool 1600 may be formed by casting or molding or any other suitable process now known or later developed. The bottom and top edge supports 1610 and 1615 may be integrally formed parts of the tool 1600 or separate parts that are attached to the tool by any suitable chemical, thermal and/or mechanical attachments.

Those skilled in the art that the various embodiments of moveable installation tools described above may be configured as stationary installation tools by providing means for temporarily securing the installation tool in a desired position, such as an aperture for receiving a screw or nail. Such stationary installation tools are intended to come within the scope of the invention.

To install siding using an exemplary system and method according to principles of the invention, an installer may first create a line (e.g., a chalk line) at a height where a starter row such as a lath strip will be located. The lath strip may be used below the first course of siding to ensure a consistent plank angle. The first plank is then positioned and fastened using installation tools according to the principles of the invention. An exemplary stationary installation tool, as shown in FIG. 12, may be utilized to facilitate positioning the first plank. The bottom side of the top edge support 1215 of the tool 1200 may be placed on the top edge of the installed lath strip, while the bottom edge of the first plank may rest on the top side of the bottom edge support 1210. Thus, the distance between the bottom side of the top edge support 1215 and the top side of the bottom edge support 1210 defines the overlap. Illustratively, if this distance is approximately 1¼″, then each course of siding will overlap the row below it by about 1¼″. Once the stationary tool 1200 is properly positioned it may be temporarily secured in place with a nail or screw through the aperture 1220 into the wall. The tool 1200 may be secured in place near the right or left end of the plank.

After the stationary tool 1200 is properly positioned and temporarily secured in place, a moveable tool may be used to align the plank to be installed. Illustratively, an exemplary moveable installation tool, as shown in FIG. 16, may be utilized to facilitate positioning the plank to be installed. The bottom side of the top edge support 1615 of the tool 1600 may be placed on the top edge of the installed lath strip, while the bottom edge of the first plank may rest on the top side of the bottom edge support 1610. Thus, the distance between the bottom side of the top edge support 1615 and the top side of the bottom edge support 1610 ensures a consistent overlap. Illustratively, if the distance is approximately 1¼″, then proper use of the tool ensures that the siding being installed will overlap the row below it by about 1¼″ at each location of the tool along the length of the plank. The moveable tool 1600 may be used at the end opposite the stationary tool, and moved in increments towards the stationary tool as the plank is secured in place with nails or screws nearby each location of the tool.

To install the next course of siding, the installer removes the stationary tool by removing the screw or nail and sliding the tool to past the end of the plank. Likewise, the installer removes the movable tool from the installed siding. Then, the installer may fasten the end of the siding. Next, the installer may secure the stationary tool 1200 in position. The bottom side of the top edge support 1215 of the tool 1200 may be placed on the top edge of the previously installed adjacent plank, while the bottom edge of the next plank may rest on the top side of the bottom edge support 1210. Once the stationary tool 1200 is properly positioned it may be temporarily secured in place with a nail or screw through the aperture 1220 into the wall. The tool 1200 may be secured in place near the right or left end of the plank.

After the stationary tool 1200 is properly positioned and temporarily secured in place, the moveable tool may be used to align the plank to be installed. The bottom side of the top edge support 1615 of the moveable tool 1600 may be placed on the top edge of the installed adjacent plank, while the bottom edge of the next plank may rest on the top side of the bottom edge support 1610. The moveable tool 1600 may be used at the end opposite the stationary tool, and moved in increments towards the stationary tool as the plank is secured in place with nails or screws nearby each location of the tool.

The installer proceeds by repeating the above procedure for each course of siding to be installed. Therefore, as this discussion demonstrates, the invention enables a single worker to efficiently and consistently achieve a high quality installation with parallel planks and a uniform exposure.

While the invention has been described in terms of various embodiments, implementations and examples, those skilled in the art will recognize that the invention can be practiced with modification within the spirit and scope of the appended claims including equivalents thereof. The foregoing is considered as illustrative only of the principles of the invention. Variations and modifications may be affected within the scope and spirit of the invention.

What is claimed is:

1. A system for installing siding, said system comprising a stationary installation tool and a moveable installation tool,
said stationary installation tool including a planar face having a front surface and a back surface, a first stationary edge support, a second stationary edge support and an attachment means, said first stationary edge support and said second stationary edge support being configured to define a determined overlap or exposure; and
said moveable installation tool including a planar face, a first moveable edge support, a second moveable edge support, said first moveable edge support and said second moveable edge support being configured to define a determined overlap or exposure.

2. A system for installing siding according to claim 1, wherein said first stationary edge support is adapted to support a portion of a bottom edge of a plank of siding to be installed.

3. A system for installing siding according to claim 2, wherein said second stationary edge support is adapted to abut a portion of a top edge of a plank of siding that has been installed.

4. A system for installing siding according to claim 3, wherein said first stationary edge support and said second stationary edge support are parallel.

5. A system for installing siding according to claim 1, wherein said attachment means is comprised of an aperture configured for receiving a mechanical attachment to secure the stationary installation tool to a wall on which siding is being installed.

6. A system for installing siding according to claim 5, wherein the distance from said aperture to said first stationary edge support is greater than the height of a plank of siding to be installed.

7. A system for installing siding according to claim 6, wherein the distance from said first stationary edge support to said second stationary edge support is less than the height of a plank of siding to be installed.

8. A system for installing siding according to claim 7, wherein said first stationary edge support protrudes from the front surface of the planar face of the stationary installation tool.

9. A system for installing siding according to claim 7, wherein said second stationary edge support protrudes from the back surface of the planar face of the stationary installation tool.

10. A system for installing siding according to claim 1, wherein said attachment means is comprised of an aperture configured for receiving a mechanical attachment to secure the stationary installation tool to a wall on which siding is being installed, said mechanical attachment being an attachment device from the group consisting of screws, nails and staples.

11. A system for installing siding according to claim 1, wherein said first moveable edge support is adapted to support a portion of a bottom edge of a plank of siding to be installed.

12. A system for installing siding according to claim 11, wherein said second moveable edge support is adapted to abut a portion of a top edge of a plank of siding that has been installed.

13. A system for installing siding according to claim 12, wherein said first moveable edge support and said second moveable edge support are parallel.

14. A system for installing siding according to claim 13, wherein the distance from said first moveable edge support to said second moveable edge support is less than the height of a plank of siding to be installed.

15. A system for installing siding according to claim 14, wherein said first moveable edge support protrudes from the front surface of the planar face of the moveable installation tool.

16. A system for installing siding according to claim 15, wherein said second moveable edge support protrudes from the back surface of the planar face of the moveable installation tool.

17. A stationary installation tool for installing siding, said stationary installation tool comprising:
a planar face having a front surface and a back surface,
a first stationary edge support,
a second stationary edge support, said first stationary edge support and said second stationary edge support being configured to define a determined overlap or exposure,
and an aperture, said aperture being adapted to enable removable attachment of the stationary installation tool to a surface on which siding is being installed.

18. A stationary installation tool according to claim 17, wherein said first stationary edge support is adapted to support a portion of a bottom edge of a plank of siding to be installed and said second stationary edge support is adapted to abut a portion of a top edge of a plank of siding that has been installed, said first stationary edge support and said second stationary edge support being substantially parallel,
wherein the distance from said aperture to said first stationary edge support is greater than the height of a plank of siding to be installed and the distance from said first stationary edge support to said second stationary edge support is less than the height of a plank of siding to be installed, and
wherein said first stationary edge support protrudes from the front surface of the planar face of the stationary installation tool and said second stationary edge support protrudes from the back surface of the planar face of the stationary installation tool.

19. A moveable installation tool for installing siding, said moveable installation tool comprising:
a planar face having a front surface and a back surface,
a first moveable edge support,
a second moveable edge support, said first moveable edge support and said second moveable edge support being configured to define a determined overlap or exposure.

20. A moveable installation tool according to claim 19, wherein said first moveable edge support is adapted to support a portion of a bottom edge of a plank of siding to be installed and said second moveable edge support is adapted to abut a portion of a top edge of a plank of siding that has been installed, said first moveable edge support and said second moveable edge support being substantially parallel,
wherein the distance from said first moveable edge support to said second moveable edge support is less than the height of a plank of siding to be installed, and wherein said first moveable edge support protrudes from the front surface of the planar face of the moveable installation tool and said second moveable edge support protrudes from the back surface of the planar face of the moveable installation tool.
